(19) United States
(12) Patent Application Publication
(10) Pub. No.: US 2023/0158408 A1
(43) Pub. Date: May 25, 2023

(54) METHOD AND APPARATUS FOR INSTALLING GAME CLIENT

(71) Applicant: NEXON KOREA CORPORATION, Seongnam-si (KR)

(72) Inventor: Ung Suk PARK, Seongnam-si (KR)

(73) Assignee: NEXON KOREA CORPORATION, Seongnam-si (KR)

(21) Appl. No.: 17/991,285

(22) Filed: Nov. 21, 2022

(30) Foreign Application Priority Data
Nov. 22, 2021 (KR) 10-2021-0161337
Dec. 14, 2021 (KR) 10-2021-0178280

(51) Int. Cl. A63F 13/77; A63F 13/79

(52) U.S. Cl. CPC A63F 13/77; A63F 13/79; A63F 2300/552

(57) ABSTRACT

Disclosed herein are a method and apparatus for installing a game client. According to an embodiment, there is provided a method for installing a game client by which an apparatus for installing a game client installs a game client, the method including: establishing a first session when the installation of a game client has started; storing play information acquired based on the first session; and updating the account of the game client based on the play information when the installation of the game client is completed.

### CROSS-REFERENCE TO RELATED APPLICATION

This application claims the benefit of Korean Patent Applications No. 10-2021-0161337 filed on Nov. 22, 2021 and No. 10-2021-0178280 filed on Dec. 14, 2021, which is hereby incorporated by reference herein in its entirety.

### BACKGROUND

### 1. Technical Field

The embodiments disclosed herein relate to a method and apparatus for installing a game client, and more particularly to a method and apparatus for installing a game client that support the play of a game being installed during the installation of the game.

### 2. Description of the Related Art

Online games have evolved dramatically in recent years. In particular, with the rapid development of data transmission speed over the Internet, users can easily enjoy games anytime, anywhere through game clients installed on their terminals.

A game can be played only when a game client is installed on a user terminal. Recently, as the quality of a game increases, the size of a game client to be downloaded also tends to increase. Accordingly, while a game client is installed on a user terminal, a user has to wait until the installation of the game client is completed. Meanwhile, when the download or installation of the game client takes a long time, the user may consider a waiting process to be boring. This may cause the user to leave the game before even playing the game.

In connection with this, according to Korean Patent No. 10-1379412 entitled “Game Patching Method capable of Automatic Patching or Installation Using Mobile Terminal, Game Provision Method, and Mobile Terminal Thereof,” the conventional technology is performed in a game provision client that is installed on a mobile terminal and is connectable to at least one game server over a network by using the communication means of the mobile terminal. The game patching method includes (a) accessing at least one game server, checking patch information, and determining whether a patch is required by comparing the patch information with patch history information, (b) if a patch is required, checking whether a connection with the game server can be set up via a preset bandwidth or wider, (c) if the connection can be set up via the preset bandwidth or wider, downloading patch data from the game server and storing the patch data in a storage means of a mobile terminal, and (d) providing the patch data stored in the mobile terminal to a game terminal when a connection is set up to the game terminal.

However, the prior art, including the above-described conventional technology, only proposes a function for automatically installing a game, and does not overcome the boredom of a user when the user is waiting for the completion of the installation of the game.

Therefore, there is a need for a new level of function for overcoming the above problem and further improving the satisfaction of a game user.

Meanwhile, the above-described background technology corresponds to technical information that has been possessed by the present inventor in order to contrive the present invention or that has been acquired in the process of contriving the present invention, and can not necessarily be regarded as well-known technology that had been known to the public prior to the filing of the present invention.

### SUMMARY

An object of the embodiments disclosed herein is to propose a method and apparatus for installing a game client.

An object of the embodiments disclosed herein is to propose a method and apparatus for supporting a user to play a game until the installation of a game client is completed.

An object of the embodiments disclosed herein is to propose a method and apparatus for simultaneously performing the installation of a game client, character setting, and/or a tutorial.

An object of the embodiments disclosed herein is to provide a method and apparatus for preventing a game user from being aware of the state of having moved to an in-game after the installation of a game client has been completed.

An object of the embodiments disclosed herein is to provide a method and apparatus for preventing a game user from leaving a game during the installation of a game client.

As a technical solution for accomplishing at least any one of the above-described objects, according to an embodiment, there is provided a method for installing a game client by which an apparatus for installing a game client installs a game client, the method including: establishing a first session when the installation of a game client has started; storing play information acquired based on the first session; and updating the account of the game client based on the play information when the installation of the game client is completed.

According to another embodiment, there is provided a non-transitory computer-readable storage medium having stored thereon a program that, when executed by a processor, causes the processor to execute a method for installing a game client, wherein the method includes establishing a first session when the installation of a game client has started, storing play information acquired based on the first session, and updating the account of the game client based on the play information when the installation of the game client is completed.

According to another embodiment, there is provided a computer program that is executed by an apparatus for installing a game client and stored in a non-transitory computer-readable storage medium in order to perform a method for installing a game client, wherein the method includes establishing a first session when the installation of a game client has started, storing play information acquired based on the first session, and updating the account of the game client based on the play information when the installation of the game client is completed.

According to still another embodiment, there is provided an apparatus for installing a game client, the apparatus including: memory; and a controller configured to form a first session when the installation of a game client has started, to store play information acquired based on the first session, and to update the account of the game client based on the play information when the installation of the game client is completed.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a diagram showing the configuration of an apparatus for installing a game client according to an embodiment;

FIG. 2 is a block diagram of the apparatus for installing a game client according to the embodiment;

FIG. 3 is a flowchart illustrating a method for installing a game client according to an embodiment;

FIGS. 4 to 7 are exemplary views illustrating the method for installing a game client according to the embodiment; and

FIGS. 8 and 9 are flowcharts illustrating methods for installing a game client according to other embodiments.

### DETAILED DESCRIPTION

Various embodiments will be described in detail below with reference to the accompanying drawings. The following embodiments may be modified to various different forms and then practiced. In order to more clearly illustrate features of the embodiments, detailed descriptions of items that are well known to those having ordinary skill in the art to which the following embodiments pertain will be omitted. Furthermore, in the drawings, portions unrelated to descriptions of the embodiments will be omitted. Throughout the specification, like reference symbols will be assigned to like portions.

Throughout the specification, when one component is described as being “connected” to another component, this includes not only a case where the one component is “directly connected” to the other component but also a case where the one component is “connected to the other component with a third component arranged therebetween.” Furthermore, when one portion is described as “including” one component, this does not mean that the portion does not exclude another component but means that the portion may further include another component, unless explicitly described to the contrary.

Embodiments will be described in detail below with reference to the accompanying drawings.

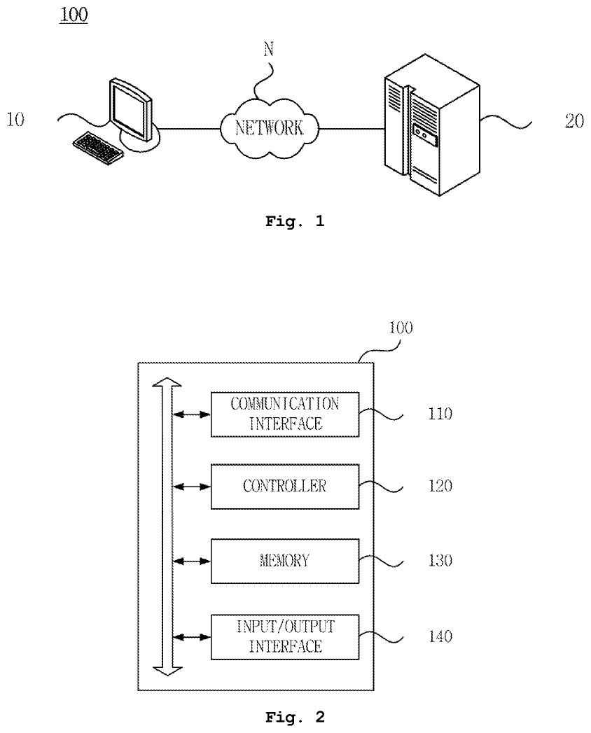

FIG. 1 is a diagram showing the configuration of an apparatus 100 for installing a game client according to an embodiment, and FIG. 2 is a block diagram of the apparatus 100 for installing a game client according to the embodiment.

The apparatus 100 for installing a game client is an apparatus that supports a game client to be installed according to a method for installing a game client.

According to the embodiment, the apparatus 100 for installing a game client may include a user terminal 10 and a server 20 as shown in FIG. 1, and the user terminal 10 and the server 20 may communicate with each other over a network N.

The user terminal 10 may have a game client installed thereon, and may display a temporary interface for interaction with a game user.

The user terminal 10 may be implemented as a computer, a mobile terminal, a television, a wearable device, or the like that can connect to a remote server over a network or connect with another terminal and a server. In this case, the computer includes, e.g., a notebook, a desktop, a laptop, and the like each equipped with a web browser. The mobile terminal is, e.g., a wireless communication device capable of guaranteeing portability and mobility, and may include all types of handheld wireless communication devices, such as a Personal Communication System (PCS) terminal, a Personal Digital Cellular (PDC) terminal, a Personal Handyphone System (PHS) terminal, a Personal Digital Assistant (PDA), a Global System for Mobile communications (GSM) terminal, an International Mobile Telecommunication (IMT)-2000 terminal, a Code Division Multiple Access (CDMA)-2000 terminal, a W-Code Division Multiple Access (W-CDMA) terminal, a Wireless Broadband (Wibro) Internet terminal, a smartphone, a Mobile Worldwide Interoperability for Microwave Access (mobile WiMAX) terminal, and the like. Furthermore, the television may include an Internet Protocol Television (IPTV), an Internet Television (Internet TV), a terrestrial TV, a cable TV, and the like. Moreover, the wearable device is an information processing device of a type that can be directly worn on a human body, such as a watch, glasses, an accessory, clothing, shoes, or the like, and can access a remote server or be connected to another terminal directly or via another information processing device over a network.

Meanwhile, the server 20 updates the account of the game client based on play information. In this case, the account of the game client refers to the account of the user terminal 10, the account of a user who controls the user terminal 10, or the account of the game client that is installed on the user terminal 10.

Furthermore, the server 20 may store various types of information required to provide a game, and may detect and record various events occurring within the game to enable the time-series progress of the game.

Furthermore, the server 20 stores various types of information for the installation of a game client, so that, when the installation of the game client on the user terminal 10 has started, the server 20 may provide the information for installation to the user terminal 10.

Furthermore, the server 20 may provide at least some of game content, which can be provided when the installation of the game client is completed, while the game client is installed on the user terminal 10.

For example, when the game content is a game that is played through interaction with another user, the server 20 may select game content requiring no interaction with another user from the game content, and may provide the selected game content to the user terminal 10.

Furthermore, for example, the server 20 may provide a tutorial. The “tutorial” is content that is provided such that a user can learn the information required to play a game, and may be, e.g., content regarding a basic operation method, game winning conditions, rules, skill combo linkers, and the like. The tutorial may include a plurality of tutorials, and may be sequentially or selectively provided according to a user's learning stage.

Furthermore, for example, the server 20 may provide character setting content. The “character setting content” refers to content that allows a user to set at least one of all information related to a game character. The character setting content may be content for setting the appearance, role, level, stat, and like of a character. A user may customize his or her character by using character setting content.

According to an embodiment, the server 20 that provides game content as described above may be implemented as at least one of a game server, a web server, and a cloud server.

For example, when the server 20 is implemented as a game server and a cloud server, the cloud server may download and store at least some of game content in advance through communication with the game server. Furthermore, for example, when the server 20 is implemented as a game server and a web server, the web server may download and store at least some of game content in advance through communication with the game server.

Meanwhile, referring to FIG. 2, the apparatus 100 for installing a game client according to the embodiment may include a communication interface 110, a controller 120, memory 130, and an input/output interface 140.

The communication interface 110 may perform wired/wireless communication with an external device or a network. For example, the communication interface 110 may transmit/receive various types of information required to perform a method for installing a game client while communicating with an external device. To this end, the communication interface 110 may include a communication module that supports at least one of various wired/wireless communication methods. For example, the communication module may be implemented in the form of a chipset.

The controller 120 according to the embodiment may control the overall operation of the apparatus 100 for installing a game client, and may include a processor such as a central processing unit (CPU) or a graphics processing unit (GPU), etc. The controller 120 may control other components included in the apparatus 100 for installing a game client to perform an operation corresponding to an input of a game user. For example, the controller 120 may execute a program stored in the memory 130 to be described later, read a file stored in the memory 130, or store a new file in the memory 130, and may store play information in the memory 130.

According to an embodiment, the controller 120 establishes a first session when the installation of a game client has started.

For example, when the executable file of the game client starts to be downloaded, the controller 120 may determine that the installation of the game client has started. Furthermore, for example, when the download of the executable file is completed and a click event for the executable file occurs or a command granting permission for the execution of the executable file is input, the executable file can start. When the executable file starts, the controller 120 may determine that the installation of the game client has started. Furthermore, for example, when a user's touch or click event for a game client launcher occurs and thus the execution of the launcher is requested, the controller 120 may determine that the installation of the game client has started.

When the installation of the game client has started, the controller 120 may establish a first session so that a user can receive game content.

According to an embodiment, the controller 120 may establish a first session for data transmission/reception between the user terminal 10, in which the game client is installed, and the server 20, and the server 20 may provide game content to the user terminal 10 via the first session.

In addition, according to an embodiment, the controller 120 may provide a temporary interface corresponding to the first session.

In connection with this, the “temporary interface” refers to an interface that is provided to a user before the completion of the installation of a game client and enables the user to play a game. In this case, providing an interface to a user means displaying the interface through the user terminal 10 so that the user can view the interface and receiving input from the user through the interface. Accordingly, the user can check game content and play a game through the temporary interface before a game client is installed.

For example, when the server 20 includes a web server, the controller 120 may establish a first session by executing a client such as a web browser capable of communicating with the web server, and may provide the web browser as a temporary interface. Alternatively, for example, when the server 20 includes a cloud server, the controller 120 may establish a first session by executing a client capable of communicating with the cloud server, and may provide the client interface for communication with the cloud server as a temporary interface.

When providing the temporary interface, the controller 120 may provide the temporary interface by locating a layer corresponding to the temporary interface on a game interface layer, or may provide the temporary interface through at least a portion of a game interface. In this case, the game interface refers to an interface that is provided to a user as a game client is executed. Accordingly, for example, when the temporary interface is a web browser, the controller 120 may provide a temporary interface through an in-game screen by displaying the window of the web browser in a partial area of a game interface, or may provide a temporary interface by displaying a web browser layer on a game interface layer. The above-described example describes a method by which a temporary interface is provided when a game interface is provided during the installation of a game client. When a game interface is not provided, the controller 120 may provide only a temporary interface.

Meanwhile, according to an embodiment, when a first session is established, the controller 120 may store play information, acquired based on the first session, in the memory 130.

In this case, the “play information” may be data transmitted and received by the user terminal 10 and the server 20 via the first session as a user plays the game content, or may be data generated based on the data that is transmitted and received via the first session. The play information may include, e.g., the data that would have been transmitted from the user terminal 10 to the game server 20 when a user plays a game after the completion of the installation of a game client on the user terminal 10. The play information may include, e.g., user login information, a user input value, a character setting value, a game play setting value based on the user input value, and various types of information related to the progress of a tutorial, etc.

The controller 120 may cause the server 20 to provide game content via the first session, and may cause the user terminal 10 to provide received game content to a user through a temporary interface. Through this, the controller 120 may store values input by the user during the play of a game or values set based on the input values in the memory 130 as play information.

For example, the server 20 may allow a game tutorial to be performed, and the controller 120 may store play information generated according to the progress of the tutorial by the user, e.g., a value set by the user during the progress of the tutorial or information about the tutorial played by user among a plurality of tutorials, in the memory 130. Furthermore, for example, the server 20 may allow game character setting to be performed, and the controller 120 may store play information generated according to the game character setting of the user, e.g., a user character setting value and/or the like, in the memory 130.

When the installation of the game client is completed, the controller 120 may update the account of the game client based on the play information.

When updating the account of the game client, the controller 120 may store play information in the account of the game client that is generated after the installation of the game client. For example, the controller 120 may match a user profile or the like to the account of the game client according to login information included in the play information. Furthermore, for example, the controller 120 may update the progress stage of the game according to a setting value included in the play information. Furthermore, for example, the controller 120 may customize a user character according to a character setting value included in the play information, and may allow the user to play the game by using the customized user character. Furthermore, for example, according to a tutorial value included in the play information, the server 20 may skip a game tutorial stage determined to have already been played by the user, and may allow a game following the tutorial stage.

Meanwhile, according to another embodiment, the controller 120 may establish a second session to update the account of the game client.

In this case, the controller 120 may establish a second session for communication with the server 20, and may transmit play information to the server 20 via the second session. In this case, the terms “first session” and “second session” are used merely to distinguish between sessions, and do not refer to specific types of sessions. For example, when play information is stored in an installation support server (not shown), the controller 120 may establish a second session between the installation support server (not shown) and the server 20, and the server 20 may acquire play information from the installation support server (not shown) via the second session.

As described above, the controller 120 may update the account of the game client based on the play information. Accordingly, the user may continuously play a game before and after the installation of the game.

Meanwhile, when the installation of the client is completed, the controller 120 may switch a screen from a temporary interface to a game interface.

For the purpose of naturally switching a screen from a temporary interface to a game interface, according to an embodiment, the controller 120 provides the temporary interface as an in-game screen by inserting the temporary interface into at least a portion of the game interface to be provided as the installation of the game client is completed. Alternatively, according to an embodiment, the controller 120 may provide a temporary interface by locating a game interface layer, to be provided as the installation of the game client is completed, under a layer corresponding to the temporary interface, and may switch a screen from the temporary interface to a game interface.

Alternatively, for the purpose of naturally switching a screen from a temporary interface to a game interface, according to an embodiment, the controller 120 may switch a screen from the temporary interface to the game interface while displaying game information, which is the same as game information provided through the temporary interface, through the game client.

In addition, the time at which the switching of a screen from a temporary interface to a game interface is performed may be implemented according to various embodiments. As an example, the controller 120 may switch a screen from a temporary interface to a game interface as soon as the installation of a game client is completed.

As another example, the controller 120 may switch a screen from a temporary interface to a game interface after a predetermined period has elapsed from the completion of the installation of a game client. To this end, the controller 120 may detect a switching point. When detecting a switching point after the completion of the installation of a game client, the controller 120 may switch a screen from a temporary interface to a game interface. In general, a game is composed of unit games each of which is provided for a predetermined period of time, and the unit games may be sequentially provided according to a time-series flow. Accordingly, there may be a switching point such as a point between unit games, e.g., a point between various stories, or a saving point for the storage of previously played game content. In other words, the switching point may refer to a point in the time-series flow of a game, and may be, e.g., the end point of a tutorial, a point between tutorials in a plurality of tutorials, the point at which character setting is completed, or the point at which a quest or a stage (a round or an edition) is finished. When the user reaches such a switching point during the play of a game, the controller 120 may switch a screen from a temporary interface to a game interface at the switching point. At the time when the interface is switched at the switching point, a subsequent unit game is provided in the flow of the game, so that a user recognizes through the user terminal 10 that the appearance of a screen has been switched, but does not recognize that a screen has been switched due to the switching of the interface. Accordingly, the switching of the interface may be implemented naturally.

Meanwhile, the controller 120 may terminate the first session after the installation of the game client has been completed. For example, the controller 120 may terminate the first session when the installation of the client is completed, may terminate the first session after play information has been transmitted to the server 20, or may terminate the first session when the interface is switched from a temporary interface to a game interface.

Referring back to FIG. 1, various types of data such as files, applications, and programs may be installed and stored in the memory 130. The controller 120 may access and use data stored in the memory 130, or may store new data in the memory 130. Furthermore, the controller 120 may execute a program installed in the memory 130. For example, the memory 130 may have a program for performing the method for installing a game client installed thereon, and may store play information according to the method for installing a game client as described above.

The input/output interface 140 according to the embodiment may include an input interface configured to receive input from a game user and an output interface configured to display information such as the result of the performance of a task or the state of the apparatus 100 for installing a game client. For example, the input/output interface 140 may include an operation panel configured to receive input from a game user, and a display panel configured to display screens.

More specifically, the input interface may include devices capable of receiving various types of inputs such as a keyboard, physical buttons, a touch screen, a camera, and/or a microphone. Furthermore, the output interface may include a display panel, and/or a speaker. However, the input/output interface 140 is not limited thereto, and may include components capable of supporting various types of input/output.

According to an embodiment, the output interface may output a temporary interface, and the input interface may receive input related to game manipulation from a game user through the temporary interface.

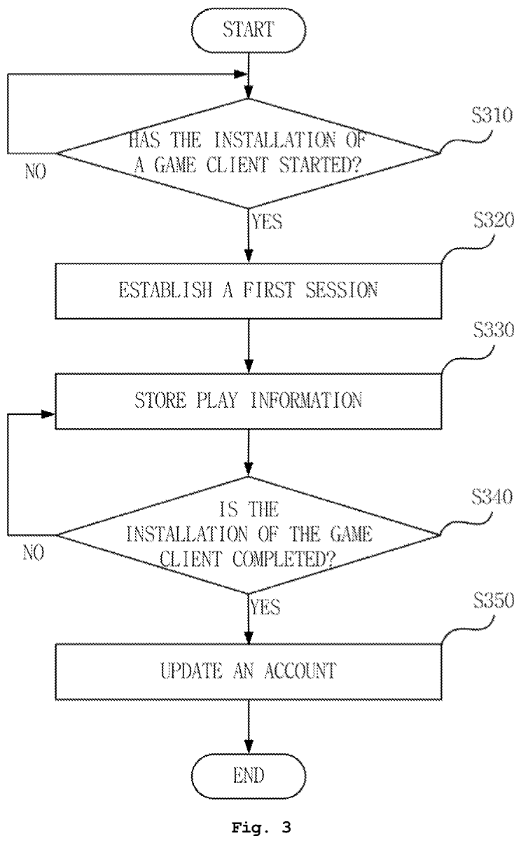

Meanwhile, FIGS. 3, 7 and 8 are flowcharts illustrating a method for installing a game client according to an embodiment. The method for installing a game client, which is shown in FIGS. 3, 7 and 8, includes steps that are processed in a time-series manner by the apparatus 100 for installing a game client, which is shown in FIGS. 1 and 2. Accordingly, the descriptions that are omitted below but have been given above in conjunction with the apparatus 100 for installing a game client, which is shown in FIGS. 1 and 2, may also be applied to the method for installing a game client, which is shown in FIGS. 3, 7 and 8. In this case, the same reference numerals denote the same objects in FIGS. 3, 7 and 8.

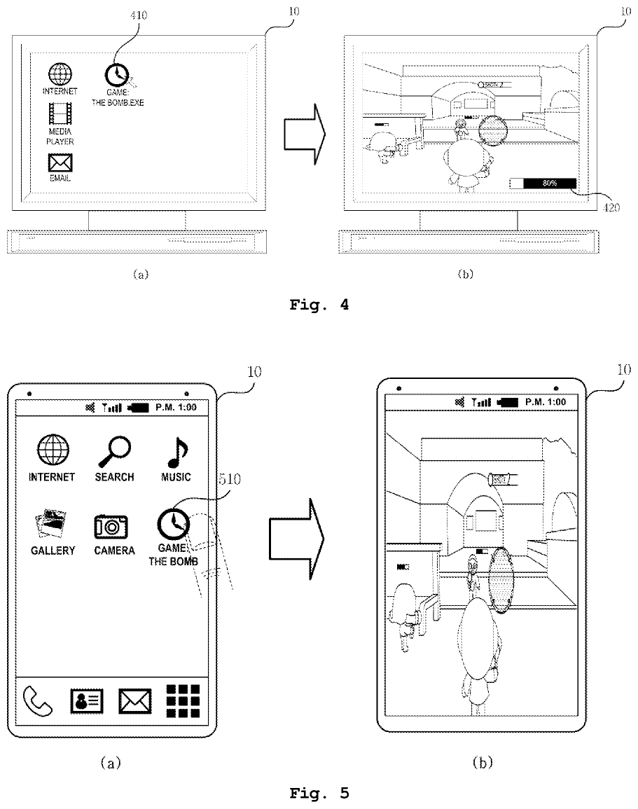

Furthermore, FIGS. 4 to 6 are exemplary views illustrating the method for installing a game client according to the embodiment disclosed herein.

As shown in FIG. 3, when the installation of a game client has started in step S310, the apparatus 100 for installing a game client may establish a first session in step S320.

In other words, the apparatus 100 for installing a game client may establish a first session between the user terminal 10 and the server 20.

In addition, a user may play game content that is provided via the first session.

In other words, as shown in FIG. 4(a), when the user executes the file “GAME: THE BOMB.EXE” 410 for executing a game client through a screen of the user terminal 10 implemented as a computer by clicking the file, the installation of the game client on the user terminal 10 may be started. Furthermore, the apparatus 100 for installing a game client may establish a first session and provide game content to the user via the first session. Accordingly, the user may play a game while the game client is installed, as shown in FIG. 4(b). Furthermore, the apparatus 100 for installing a game client may optionally provide a status bar 420 indicating the degree of download on one side of a screen, so that the user can also check the progress of the installation of the game client while playing the game.

In addition, as shown in FIG. 5(a), when the user executes a launcher icon 510 for the execution of a game client by clicking the launcher icon 510 through a screen of the user terminal 10 implemented as a mobile terminal, the installation of the game client on the user terminal 10 may be started. Furthermore, the apparatus 100 for installing a game client may establish a first session and provide game content to the user via the first session. Accordingly, the user may play a game while the game client is installed, as shown in FIG. 5(b).

According to an embodiment, the apparatus 100 for installing a game client may provide game content to the user through a temporary interface corresponding to the first session. For example, the apparatus 100 for installing a game client may provide a quest, included in the game content acquired via the first session, to the user through the temporary interface. Furthermore, for example, the apparatus 100 for installing a game client may provide a tutorial, included in the game content acquired via the first session, to the user through the temporary interface. Furthermore, for example, the apparatus 100 for installing a game client may provide character setting content, included in the game content acquired via the first session, to the user through the temporary interface.

When the user plays a game while the game client is installed as described above, the apparatus 100 for installing a game client may acquire play information and store the acquired play information in step S330. For example, as the user plays the game content, the apparatus 100 for installing a game client may store a value set for a character as play information or store an information value regarding a tutorial performed by the user as play information.

In addition, when the installation of the game client is completed in step S340, the apparatus 100 for installing a game client may update the account of the game client based on the stored play information in step S350.

Furthermore, the apparatus 100 for installing a game client may switch a screen from a temporary interface to a game interface. In this case, for the purpose of naturally switching the screen, the apparatus 100 for installing a game client may wait until the game content played by the user reaches a switching point included in the game content even when the installation of the client is completed, and may switch a screen from a temporary interface to a game interface when detecting the point, at which the user plays the game, as a switching point.

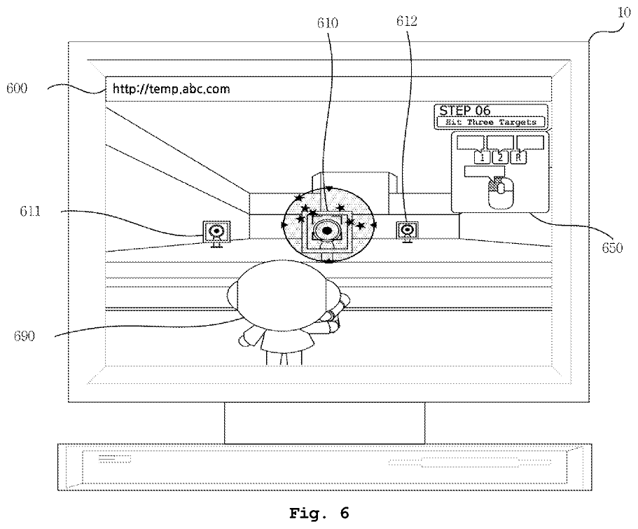

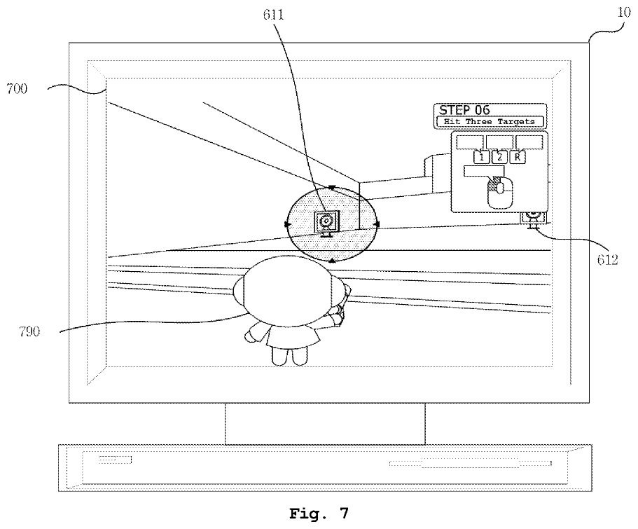

In connection with this, FIGS. 6 and 7 are exemplary views illustrating the method for installing a game client. FIG. 6 shows a screen of the user terminal 10 while the game client is installed, and FIG. 7 shows a screen that appears after the game client is installed.

As shown in FIG. 6, the first session is a web session, and game content may be displayed via a temporary interface 600 through the execution of a web application. Furthermore, for example, a user may perform a tutorial from which how to hit targets 610, 620 and 630 can be learned while checking a manual 650, and may aim at and destroy the target 610 by controlling a user character 690.

The apparatus 100 for installing a game client may store play information while the game content is provided through the temporary interface 600 as described above. The apparatus 100 for installing a game client may update the account of the game client based on the stored play information when the installation of the game client is completed. In this case, the apparatus 100 for installing a game client may switch a screen from the temporary interface 600 to a game interface 700. Accordingly, a game screen into which the play information, which is stored during the installation of the game client, is incorporated may be provided through the game interface 700. In other words, a game screen continuous with the game screen shown in FIG. 6 may be displayed to the user, as shown in FIG. 7. Therefore, the user may play the game while controlling a user character 790 having the same setting value as the controlled user character 690 during the installation of the game client. When the target 610 has been destroyed during the installation of the game client, the user may check the remaining two targets 611 and 612 and then continuously play the game in the state in which the target 610 has been destroyed, as shown in FIG. 7. In other words, the user may continuously play the game while destroying the target 611 or the target 612 without needing to recognize that the game is interrupted.

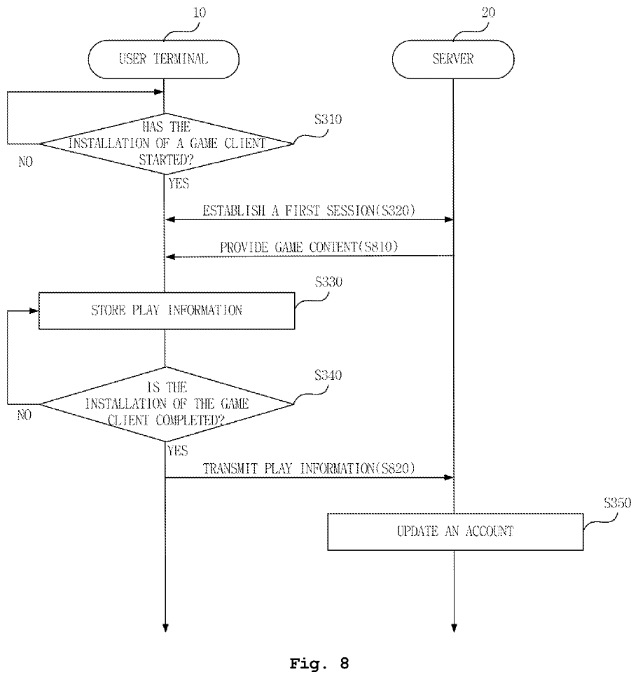

Meanwhile, as shown in FIG. 8, according to another embodiment, when the installation of a game client on the user terminal 10 has started in step S310, the apparatus 100 for installing a game client may establish a first session between the user terminal 10 and the server 20 in step S320.

In addition, the server 20 may provide game content via the first session in step S810.

The apparatus 100 for installing a game client may store play information acquired as the user plays game content in step S330, and may store it in the user terminal 10, as shown in FIG. 8.

Thereafter, when the installation of the game client on the user terminal 10 is completed in step S340, the apparatus 100 for installing a game client may transmit the play information stored in the user terminal 10 to the server 20 in step S820, and may update the client account of the server 20 based on the play information in step S350. In connection with this, when transmitting the play information stored in the user terminal 10 to the server 20, the apparatus 100 for installing a game client may transmit the play information to the server 20 via the first session or via a session that is established as the installation of the game client is completed.

Although the above-described embodiment is an embodiment in which play information is stored in the user terminal 10, the apparatus 100 for installing a game client may store play information in the server 20. Accordingly, when play information is stored in the server 20, the apparatus 100 for installing a game client may request the server 20 to update the account of the game client based on the stored play information.

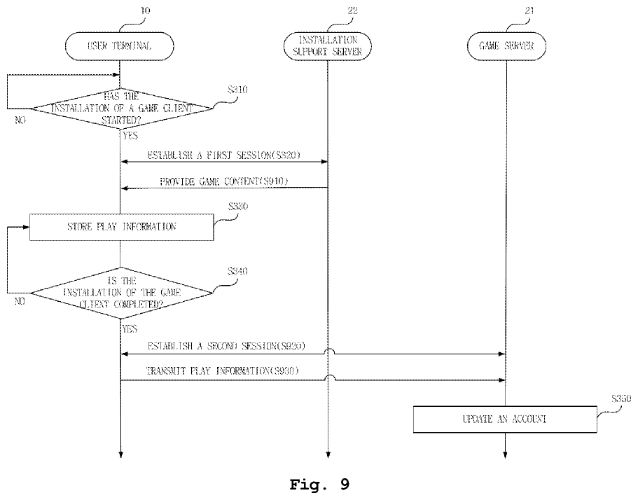

Meanwhile, as shown in FIG. 9, according to another embodiment, the server 20 may be divided into a game server 21 and an installation support server 22. The game server 21 is a server that allows a game to be played while communicating with a game client as the game client is executed. The installation support server 22 may support game play according to the method for installing a game client before the game client and the game server communicate with each other. This installation support server 22 may be implemented as a web server or a cloud server.

Accordingly, when the installation of the game client on the user terminal 10 has started in step S310, the apparatus 100 for installing a game client may establish a first session between the user terminal 10 and the installation support server 22 in step S320.

In addition, the installation support server 22 may provide game content via the first session in step S910.

As the user plays the game content, the apparatus 100 for installing a game client may store acquired play information in step S330, and may store it in the user terminal 10, as shown in FIG. 9. In connection with this, the play information may be stored in the installation support server 22 rather than the user terminal 10, or may be distributed between and stored in both of the user terminal 10 and the installation support server 22.

When the installation of the game client on the user terminal 10 is completed in step S340, the apparatus for installing a game client 10 may transmit the play information, stored in at least one of the user terminal 10 and the installation support server 22, to the game server 21.

To this end, the apparatus for installing a game client 10 may establish a second session between at least one of the user terminal 10 and the installation support server 22, and the game server 21 in step S920, and may transmit the stored play information to the game server 21 via the second session in step S930. In connection with this, although FIG. 9 shows a case in which play information is stored in the user terminal 10 and also the play information is transmitted from the user terminal 10 to the game server 21 for ease of description, the play information stored in the installation support server 22 may also be transmitted to the game server 21 because the play information may also be stored in the installation support server 22 as described above.

In addition, the game server 21 may update the account of the game client based on the play information in step S350.

In the prior art, during the installation of a game client, a user waits, an image is provided, or a mini-game different from a game being installed is provided. A user who has an expectation for a game to be installed easily loses his or her expectation during a game installation process due to the prior art, and accordingly a problem arises in that he or she leaves the game even before the game is installed. According to the method for installing a game client according to the above-described embodiment, the above-described problem may be overcome.

In other words, according to the method for installing a game client according to the above-described embodiment, a user may play a corresponding game while a game client is installed. Furthermore, according to the method for installing a game client according to the above-described embodiment, a user may continuously play a game, played during the installation of a game, even after the installation of the game. A user may be prevented from being aware of whether the installation of the game is completed. Through this, a user may be prevented from leaving a game during the installation of the game.

The term “unit” used in the above-described embodiments means software or a hardware component such as a field-programmable gate array (FPGA) or application-specific integrated circuit (ASIC), and a “unit” performs a specific role. However, a “unit” is not limited to software or hardware. A “unit” may be configured to be present in an addressable storage medium, and also may be configured to run one or more processors. Accordingly, as an example, a “unit” includes components, such as software components, object-oriented software components, class components and task components, processes, functions, attributes, procedures, subroutines, segments in program code, drivers, firmware, microcode, circuits, data, a database, data structures, tables, arrays, and variables.

Components and a function provided in “unit(s)” may be coupled to a smaller number of components and “unit(s)” or divided into a larger number of components and “unit(s).”

In addition, components and “unit(s)” may be implemented to run one or more central processing units (CPUs) in a device or secure multimedia card.

The method for installing a game client according to the embodiments described with reference to FIGS. 3, 8, and 9 may be implemented in the form of a computer-readable medium that stores instructions and data that can be executed by a computer.

In this case, the instructions and the data may be stored in the form of program code, and may generate a predetermined program module and perform a predetermined operation when executed by a processor. Furthermore, the computer-readable medium may be any type of available medium that can be accessed by a computer, and may include volatile, non-volatile, separable and non-separable media. Furthermore, the computer-readable medium may be a computer storage medium. The computer storage medium may include all volatile, non-volatile, separable and non-separable media that store information, such as computer-readable instructions, a data structure, a program module, or other data, and that are implemented using any method or technology. For example, the computer storage medium may be a magnetic storage medium such as an HDD, an SSD, or the like, an optical storage medium such as a CD, a DVD, a Blu-ray disk or the like, or memory included in a server that can be accessed over a network.

Furthermore, the method for installing a game client according to the embodiments described with reference to FIGS. 3, 8, and 9 may be implemented as a computer program (or a computer program product) including computer-executable instructions. The computer program includes programmable machine instructions that are processed by a processor, and may be implemented as a high-level programming language, an object-oriented programming language, an assembly language, a machine language, or the like. Furthermore, the computer program may be stored in a tangible computer-readable storage medium (for example, memory, a hard disk, a magnetic/optical medium, a solid-state drive (SSD), or the like).

Accordingly, the method for installing a game client according to the embodiments described with reference to FIGS. 3, 8, and 9 may be implemented in such a manner that the above-described computer program is executed by a computing apparatus. The computing apparatus may include at least some of a processor, memory, a storage device, a high-speed interface connected to memory and a high-speed expansion port, and a low-speed interface connected to a low-speed bus and a storage device. These individual components are connected using various buses, and may be mounted on a common motherboard or using another appropriate method.

In this case, the processor may process instructions within a computing apparatus. An example of the instructions is instructions which are stored in memory or a storage device in order to display graphic information for providing a Graphic User Interface (GUI) onto an external input/output device, such as a display connected to a high-speed interface. As another embodiment, a plurality of processors and/or a plurality of buses may be appropriately used along with a plurality of pieces of memory. Furthermore, the processor may be implemented as a chipset composed of chips including a plurality of independent analog and/or digital processors.

Furthermore, the memory stores information within the computing device. As an example, the memory may include a volatile memory unit or a set of the volatile memory units. As another example, the memory may include a non-volatile memory unit or a set of the non-volatile memory units. Furthermore, the memory may be another type of computer-readable medium, such as a magnetic or optical disk.

In addition, the storage device may provide a large storage space to the computing device. The storage device may be a computer-readable medium, or may be a configuration including such a computer-readable medium. For example, the storage device may also include devices within a storage area network (SAN) or other elements, and may be a floppy disk device, a hard disk device, an optical disk device, a tape device, flash memory, or a similar semiconductor memory device or array.

According to any one of the above-described solutions, there are proposed the method and apparatus for installing a game client.

According to any one of the above-described solutions, there are proposed the method and apparatus for supporting a user to play a game until the installation of a game client is completed.

According to any one of the above-described solutions, there are proposed the method and apparatus for simultaneously performing the installation of a game client, character setting, and/or a tutorial.

According to any one of the above-described solutions, there are proposed the method and apparatus for preventing a game user from being aware of the state of having moved to an in-game after the installation of a game client has been completed.

According to any one of the above-described solutions, there are proposed the method and apparatus for preventing a game user from leaving a game during the installation of a game client.

The effects that can be obtained by the embodiments disclosed herein are not limited to the effects described above, and other effects not described above will be clearly understood by those having ordinary skill in the art, to which the present invention pertains, from the foregoing description.

The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued through the present specification should be defined by the attached claims, rather than the detailed description. All modifications and variations which can be derived from the meanings, scopes and equivalents of the claims should be construed as falling within the scope of the present invention.

What is claimed is:

1. A method for installing a game client by which an apparatus for installing a game client installs a game client, the method comprising:
establishing a first session when installation of a game client has started;
storing play information acquired based on the first session; and
updating an account of the game client based on the play information when the installation of the game client is completed.

2. The method of claim 1, wherein storing the play information comprises storing play information acquired based on game content provided via the first session.

3. The method of claim 1, wherein establishing the first session comprises providing a temporary interface corresponding to the first session.

4. The method of claim 3, further comprising switching a screen from the temporary interface to a game interface of the game client when the installation of the game client is completed.

5. The method of claim 3, further comprising switching a screen from the temporary interface to a game interface of the game client when the installation of the game client is completed and also a switching point is detected.

6. The method of claim 1, wherein updating the account of the game client comprises:
establishing a second session when the installation of the game client is completed; and
transmitting the play information via the second session.

7. A non-transitory computer-readable storage medium having stored thereon a program that, when executed by a processor, causes the processor to execute the method for installing a game client set forth in claim 1.

8. A computer program that is executed by an apparatus for installing a game client and stored in a non-transitory computer-readable storage medium in order to perform the method for installing a game client set forth in claim 1.

9. An apparatus for installing a game client, the apparatus comprising:
memory; and
a controller configured to establish a first session when installation of a game client has started, to store play information acquired based on the first session, and to update an account of the game client based on the play information when the installation of the game client is completed.

10. The apparatus of claim 9, wherein the controller is further configured to store play information acquired based on game content provided via the first session.

11. The apparatus of claim 9, wherein the controller is further configured to provide a temporary interface corresponding to the first session.

12. The apparatus of claim 11, wherein the controller is further configured to switch a screen from the temporary interface to a game interface of the game client when the installation of the game client is completed.

13. The apparatus of claim 11, wherein the controller is further configured to switch a screen from the temporary interface to a game interface of the game client when the installation of the game client is completed and also a switching point is detected.

14. The apparatus of claim 11, wherein the controller is further configured to provide the temporary interface through at least a portion of a game interface of the game client.

15. The apparatus of claim 11, wherein the controller is further configured to provide a layer corresponding to the temporary interface on a game interface layer of the game client.

16. The apparatus of claim 9, wherein the controller is further configured to:
establish a second session when the installation of the game client is completed; and
transmit the play information via the second session.

17. The apparatus of claim 9, wherein the controller is further configured to store play information acquired according to a progress of a tutorial for a game provided via the first session.

18. The apparatus of claim 9, wherein the controller is further configured to store play information acquired according to a progress of character setting content for a game provided via the first session.
